(19) United States
(12) Patent Application Publication
(10) Pub. No.: US 2006/0239673 A1
(43) Pub. Date: Oct. 26, 2006

(54) Camera illumination system

(75) Inventor: John Mansbridge, Stockbridge, Hampshire (GB)

Correspondence Address: CROWELL & MORING LLP;INTELLECTUAL PROPERTY GROUP, P.O. BOX 14300, WASHINGTON, DC, 20044-4300, US

(73) Assignee: ROKE MANOR RESEARCH LIMITED, Romsey, Hampshire (GB)

(21) Appl. No.: 10/547,284

(22) PCT Filed: Mar. 8, 2004
(86) PCT No.: PCT/EP04/02341

§ 371 Date: May 4, 2006

(30) Foreign Application Priority Data
Mar. 13, 2003 (GB) 0305715
Dec. 18, 2003 (GB) 03292554

(51) Int. Cl. G03B 15/03

(52) U.S. Cl. 396/155

(57) ABSTRACT

Methods and apparatus are provided for forming an image (68) of a scene (18) comprising a source of emitted or reflected light. The scene is illuminated (54) and a first image corresponding to the illuminated scene is recorded. Illumination is ceased, and a second image of the emitted or reflected light, corresponding to the non-illuminated scene, is recorded. The second image is used to generate a marker in the first image, said marker indicating the position of the emitted or reflected light.

The present invention relates to methods and apparatus for forming an image of a scene which comprises a source of emitted or reflected light. The invention more particularly relates to forming an image of such a scene which may be illuminated in a controlled manner.

In certain particular embodiments, the invention provides methods and apparatus for improved image forming in endoscopes and similar inspection equipment.

The present invention may be used to form colour or monochrome images.

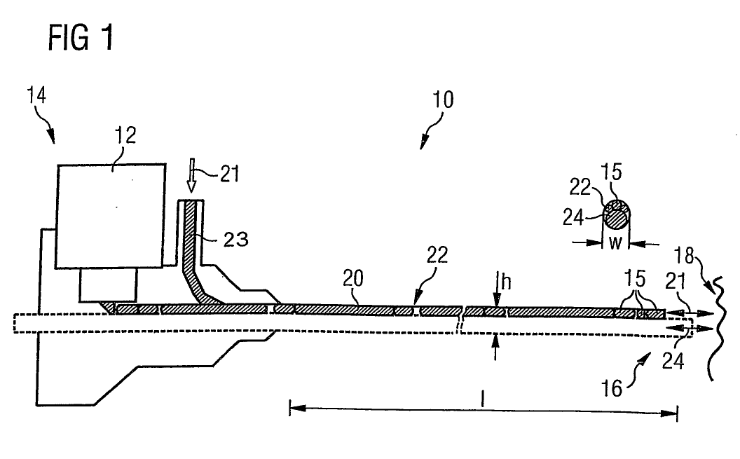

FIG. 1 shows a known type of endoscope, such as is used in surgery. Similar apparatus may be envisaged for internal inspection of machines, or other relatively enclosed environments. Both endoscopes and such similar apparatus are addressed by the present invention.

FIG. 1 shows an endoscope 10 with a camera 12 at a proximal end 14, distant from a distal end 16, which is placed in the vicinity of a scene 18 to be viewed. One or more objective lenses 15 form an optical image of the scene 18 to be viewed. The optical image is relayed from the distal end 16 to the camera 12 by a series of relay lenses 20, which are typically in the form of rods. These rods are rigidly mounted in a tube 22. This arrangement precludes the development of an endoscope with any significant degree of articulation in the tip. The scene 18 is illuminated by light 21 provided along an illumination path 22 which may comprise a series of rigid lenses and/or a number of optical fibres. Light 21 is reflected by the scene 18 and part of that light returns to the objective lenses 15 to form the optical image. A path 24 provides access to the scene for a tool, not illustrated. Such tools may be provided for cutting or laser ablation for example.

The purpose of this image-forming arrangement, which may be referred to as an optical relay is to enable the optical image to be formed in a relatively large camera 12. This enables commercial high-quality and high-resolution cameras 12 to be used. Such a large camera could not be located at the distal end 16 without making the width w and height h of the tube 22 unacceptably large for use as an endoscope. However, the use of rigid relay lenses 21 means that the endoscope tube 22 cannot be made flexible. Typically the width w is about 4.5 mm, while the height h is about 2.2 mm. The length l of the tube 22 may be about 200-300 mm

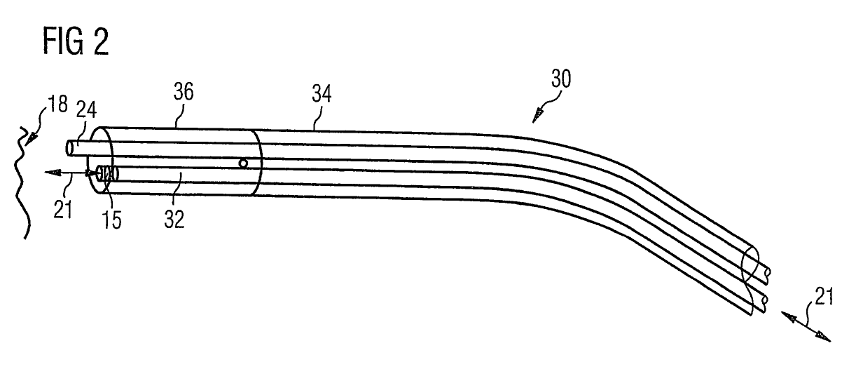

An alternative arrangement for an endoscope 30 is shown in FIG. 2. In this example, an optical image of the scene 18 is formed by one or more objective lenses 15. The optical image is formed on the end of a bundle 32 of optic fibres. The fibres are bonded together at the ends but are separated along most of their length. The optical image is focused on a plane coincident with the ends of the bundle of fibres. Each fibre carries one pixel of the image. The pixel count for the image accordingly depends upon the number of fibres used and the quality of the image relies also on each fibre being in the same position, with respect to its neighbours, at both ends. The optical image carried by the fibres is then transferred to an imaging device, such as a charge-coupled device (CCD). The CCD preferably provides at least one pixel of image resolution for each fibre in the fibre bundle 32. The final image quality is limited by the size of the individual fibres and in many applications the resulting image quality is unacceptable. As the optical fibres 32 are flexible, being separate over most of their length, this endoscope may be made flexible to a certain extent by encasing it within a flexible tube 34. A mechanically steer-able end 36 allows the direction of insertion to be controlled as the endoscope is inserted, for example, into a human or animal body. The path 24 for tools, and the tools themselves must be of a correspondingly flexible design. One drawback of this design, particularly in the surgical environment, is that it is susceptible to biological contamination. The tube 34 may not be fully sealed, and biological contamination which gets between the very many optical fibres is virtually impossible to remove. The combination of objective lenses and optic fibre is very expensive, and cannot be economically regarded as a disposable item.

The camera 12 is typically linked to a display, recording and/or processing unit via a flexible link.

A further alternative approach is to place a camera, typically a CCD, at the distal end 16 of the instrument. This would mean that optical processing of the image takes place entirely at the distal end 16, that there is no difficulty in housing rigid relay lenses 20, nor image quality limitations due to the size of the optic fibres. The image would be encoded, for example into a digital representation, at the distal end, and the encoded representation of the image transferred along the endoscope to the proximal end 14 over a small number of electrical wires, or an optic fibre or the like. The endoscope tube could accordingly be made more flexible than otherwise possible, and could be made steer-able in a manner such as that illustrated in FIG. 2. However, this arrangement is limited by the small dimensions h, w of the endoscope tube. The entire tube has a typical mean diameter of about 5 mm. Within this limited area, a camera such as a CCD imaging device must be provided, along with a source of illumination and the path for tools. This means that the CCD camera used must be very small. Typically, the CCD camera should have a diameter in the order of 1 mm, having about 300 pixels across the diameter. Since the pixels cannot be made smaller than a certain size without becoming unfeasible or very insensitive to light, the size limitation sets a limit to the number of pixels available for encoding the image and therefore the camera resolution.

Conventional colour cameras have pixels arranged in groups of three or four with each pixel in group made sensitive to only one of a set of complementary colours, typically red, green and blue, usually by placing a matrix of colour filters in front of the pixel sensors. Thus a full-colour pixel is composed of a group of three or four single-colour pixels. Correspondingly, in a coloured imager, in order to achieve comparable resolution to a monochrome imager the total number of pixels must be increased by a corresponding factor of three or four. This is a severe disadvantage for miniature imagers, such as CCD, of the type required for applications such as endoscopes.

One way of avoiding this problem is to employ a monochrome camera, but to cyclically illuminate the scene with the complementary colours for successive image frames, then to combine these successive frames together to form a colour image having a number of colour pixels equal to the number of single-colour pixels on the camera CCD. The successive colours may be generated in ways known per se, such as generation from white light by use of dichroic filter blocks, or use of respectively coloured LEDs. In this way the camera may be very simple and with the largest possible pixel sensors for a given number of pixels and camera size. This approach to making a colour camera enables the effective size of the full colour pixel sensors to be increased by a factor of 3 or 4 in area thus achieving a considerable increase in the imaging resolution. This arrangement is termed a frame sequential colour camera

In a number of medical applications of endoscopy, lasers are used to remove tissue. These lasers are usually invisible. To enable the surgeon to see where the laser is pointing, the laser spot is ‘marked’ on the scene by a complementary visible laser, typically coloured red. If a frame sequential camera is used the marker will appear white instead of red, since the red light reflected from the scene will be detected in each of the sequential frames, and so will be represented in red, green and blue frames, providing a white marker in the final image. This is disadvantageous since a white marker is difficult to distinguish from ‘glints’ caused by the illumination. Since the illumination is typically applied from a same direction regardless of the colour, the ‘glints’ will occur in the same position in each of the sequential frames, providing a white ‘glint’ in the final colour image.

Use of a monochrome camera provides a monochrome image in which it may be difficult to distinguish the marker from ‘glints’ or pale coloured artefacts within the scene.

U.S. Pat. No. 6,449,006 describes an LED illumination system for endoscopic cameras. The illumination system for an endoscopic camera has a plurality of light emitting diodes mounted to a substrate. The substrate is adapted for attachment at the distal end of the endoscope. Each LED is contained within a reflector cup, which directs the angular dispersion of emitted light toward the object to be viewed U.S. Pat. No. 4,713,683 describes an illuminating and synchronizing device for colour imaging equipment. An illuminating device is provided to serve as a lighting source for a subject to be imaged by colour imaging equipment and as a source of synchronizing signals. The device is adjustable to provide light that complements the spectral response characteristics of the solid state image pick-up device used. The device includes a rotating colour filter disc interposed between the subject and a source of light, and can be arranged to adjust the amount of light of each of the three primary colours irradiated on the subject by initially selecting the respective areas of each colour filter for transmitting each colour and/or by sequentially adjusting the intensity of the light source in synchronism with each of the colour filter areas passing before it and the synchronizing signals are generated by openings formed in light shielding regions of the disc.

The present invention accordingly aims to alleviate at least some of the difficulties of the prior art. In particular, the present invention provides a method for forming an image of a scene comprising a source of emitted or reflected light. The method comprises the steps of: illuminating the scene and recording a first image corresponding to the illuminated scene; ceasing illumination of the scene, and recording a second image of the emitted or reflected light, corresponding to the non-illuminated scene; adding a marker into the first image, said marker indicating the position of the emitted or reflected light in the second image.

The step of illuminating the scene and recording a first image corresponding to the illuminated scene may comprise the sub-steps of: illuminating the scene with a selected colour of light; recording an image corresponding to the scene illuminated by the selected colour of light; repeating the preceding two sub-steps with at least one further selected colour of light; and assembling the recorded images together to form a colour image corresponding to the scene, being the said first image.

The step of adding a marker into the first image may comprise selecting a representation of the marker which offers high contrast with respect to the surrounding part of the first image.

The selection of a representation may comprise selection of a colour in which the marker is shown in the resulting image; or selection of a texture in which the marker is shown in the resulting image; or generation of a contour ring, which is shown in the resulting image.

The method may further comprise the step of subtracting the second image from the first image, to remove the image of the marker from the first image, leaving an image substantially corresponding to the scene without the marker.

The method may comprise the step of inhibiting the source of emitted or reflected light during the step of illuminating the scene and recording a first image corresponding to the illuminated scene.

The present invention also provides apparatus for forming an image of a scene comprising a source of emitted or reflected light. The apparatus comprises: a source of light for illuminating the scene; a controller for controlling operation of the source of light; storage means for recording a first image corresponding to the scene illuminated by the source of light; further storage means for recording a second image of the emitted or reflected light, corresponding to the non-illuminated scene; and an image processing device for adding a marker into the first image, said marker indicating the position of the emitted or reflected light in the second image.

In certain embodiments of the apparatus, the controller controls the light source to illuminate the scene sequentially with a plurality of selected colours of light. In certain embodiments of the apparatus, the storage means comprises a corresponding plurality of storage means, each for recording a corresponding an image for the scene illuminated by a respective one of the plurality of selected colours of light. In certain embodiments, the apparatus further comprises an image processing device for combining the recorded images together to form a colour image corresponding to the scene, being the said first image.

The marker added into the first image may comprise a representation of the marker, the representation being selected to offer high contrast with respect to the surrounding part of the first image. The representation may comprises a colour in which the marker is shown in the resulting image; or a texture in which the marker is shown in the resulting image; or a contour ring, which is shown in the resulting image.

In certain embodiments of the apparatus, the controller controls the source of emitted or reflected light while the scene is illuminated.

The present invention applies a variation of the frame sequential camera technique to provide an improved imaging technique applicable particularly to endoscope imaging or similar applications where a marker light is used.

As discussed in relation to the prior art, a marker light, such as a red laser shone at a scene to indicate to a surgeon where a laser ablation tool is aimed, may be difficult to identify in a frame sequential colour image. The present invention aims to provide a method and apparatus which enables images to be produced wherein the marker, or other source of emitted or reflected light comprised within the scene, may be clearly identified.

In the following description, the term ‘marker’ primarily indicates a reflection of a light beam shone at a scene to indicate a particular location, but also includes all similar sources of emitted or reflected light comprised within the scene. The terms ‘camera’ and ‘CCD’ are to be interpreted as representing cameras, including charge coupled devices, along with all other suitable imaging devices.

According to the present invention, further non-illuminated frames are inserted into the frame sequence. These non-illuminated frames will be referred to hereafter as dark frames. In a dark frame, only the marker light will be seen by the camera. The resulting colour frame sequential image will be made up of data derived from four monochrome images: red, green, blue and dark.

A dark frame contains an image only of the marker. The image of the marker may be combined with the red-green-blue frame sequential image in any of a number of ways. A corresponding marker may be added to the final image in a colour of choice, or the location of the marker may otherwise be indicated by chosen video effects.

In an endoscope application, the marker used needs to be of a colour that is reflected by the tissue being treated. If the tissue is highly absorbent to the marker colour the marker will be substantially absorbed and will be difficult to see. Thus for most operations red is chosen as the marker colour since most body tissues reflect a high proportion of red light. However, this means that the surgeon will often encounter an image comprising a red marker on a red background. This reduces the effectiveness of the marker. Using the dark frame approach of the present invention, red light can be used to generate the marker image, but the marker can be displayed on a screen in the final image as any colour chosen by the surgeon. The surgeon could also choose other effects to make the maker clearly distinguished from the surrounding image, such as flashing or textured, for exampled with stripes or a chequered pattern.

This approach could also usefully be applied to a standard camera with groups of colour sensitive pixels, as opposed to a frame sequential colour camera, where periodic dark frames could be inserted by extinguishing the scene illumination for the time taken to record the dark frames, to enable an artificial marker to be generated in standard colour images. The present invention accordingly allows clear identification of markers in images taken by any type of camera, provided that the ambient illumination of the scene may be controlled.

In certain embodiments, the marker light could be on only during the dark frames, and extinguished during illuminated frames. This will make it easier to separate the marker from the rest of the image, because the marker will only be present in the dark frame image, whereas if the marker is always on it will be in both the dark frame and also in the sequential illuminated frames. This technique will prevent the light of the marker from interfering with the images in the illuminated frames.

In certain embodiments, information from the dark frame may be used to subtract the marker from the normal, illuminated image frames.

The user, for example a surgeon using laser ablation endoscopy, may select a preferred or most effective way of displaying the marker on the final image. The surgeon may use a colour similar to the actual marker colour or a completely different colour may be chosen, for example, to contrast with the scene.

The marker light can also be a colour that can be seen by the camera but would be invisible to the human eye, or in a normal image. An example of this is to use infrared light as the marker. The camera would need to be sensitive to infrared light. The marker may be illuminated only during dark frames. The resulting sequential images may be treated as described for those using visible markers.

In addition to its application to frame sequential colour imaging, the present invention may be adapted to provide a type of frame sequential monochrome imaging, wherein a monochrome camera CCD is used, and the scene is illuminated in alternate frames, the remaining frames being un-illuminated. The marker, or other source of emitted or reflected light comprised within the scene, will alone be detected during dark frames. The images from illuminated and dark frames may be combined in a manner similar to that discussed in relation to frame sequential colour camera, to highlight the position of the marker.

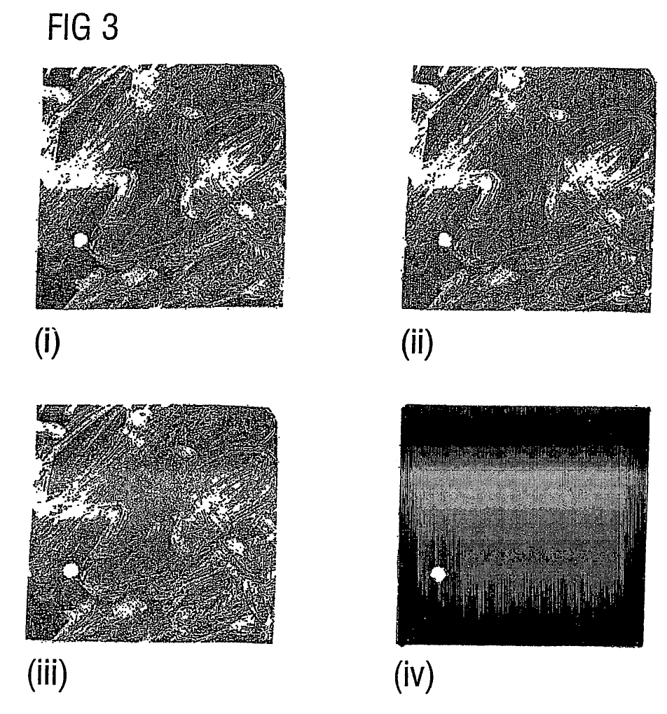

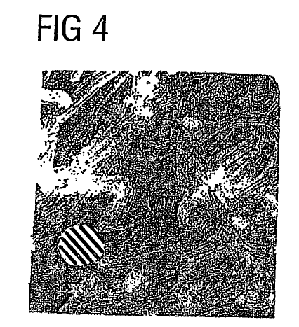

FIGS. 3-4 illustrate images formed according to an embodiment of the present invention. In FIG. 3, images (i)-(iii) show the frames produced respectively by the camera CCD when illuminated by red, green and blue light. Although the marker is present in these images, it is difficult to distinguish from other features of the scene. Image (iv) of FIG. 3 shows the image recorded during the dark frame. The marker is substantially the only feature seen in this image. Some other pixels may detect some light, reflected from the marker illumination. This image may be cleaned by image processing techniques known in themselves to isolate the representation of the marker. A shrink function should delete the spurious other features, leaving the marker alone and clearly shown. The location of the marker may then be emphasised for clarity in the final image, for example as shown in FIG. 4. While shown as monochrome stripes in FIG. 4, the location of the marker may, in practice, be shown in any pattern, in a contrasting colour, blinking or as an outline, again in a contrasting colour and/or blinking, or any combination of these. In order to provide an outline indication of the location of the marker, a contour function may be provided. Considering the dark frame image of FIG. 3 (iv), the marker will probably return a very high light level at its centre, tailing away to a lesser value towards its edge. At least some of these values will be higher than those returned by the spurious light pixels over the remainder of the image. By setting a contour value less than the peak light level of the marker, but preferably greater than the light levels returned by the spurious light pixels, an image processing method will generate a contour ring corresponding to the chosen contour and indicating the position of the marker. This contour ring may be shown on the final image in any pattern, in a contrasting colour, blinking, or any combination of these. If the marker is turned on only during dark frames, the contour ring may show an unimpeded image of the scene within the contour ring, allowing the user to clearly identify the feature indicated by the marker.

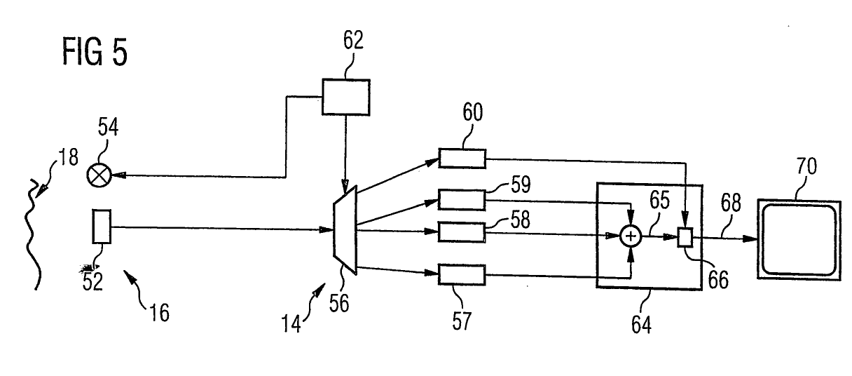

FIG. 5 shows an apparatus according to an embodiment of the present invention. A camera CCD, for example a monochrome CCD, 52 is located at the distal end 16 of an endoscope, in proximity to a scene 18 to be viewed. Illumination of the scene is provided, and this is very schematically indicated at 54. The camera CCD 52 provides its images to a multiplexer 56, itself connected to four frame stores 57, 58, 59, 60. A controller 62 controls the colour and presence of illumination 54 and the operation of the multiplexer 56 to ensure that images captured by the camera CCD 52 when the scene 18 is illuminated by red light are stored in red frame store 57; similarly, blue images are stored in blue frame store 58 and green images in green frame store 59. Every fourth frame is a dark frame. During a dark frame, controller 62 causes the illumination 54 to be extinguished. The images captured by the camera CCD 52 during the dark frame are stored in dark frame store 60. An image processing device 64 receives the red green and blue images and combines them into a representation 65 of a colour image. A further image processing device 66 receives the dark frame image, representing the marker, and applies a corresponding marker into the colour image. The final image signal 68 is provided to a display, recorder or other output device 70. The final image will contain a highlighted marker position indicator as discussed elsewhere in this description.

The present invention accordingly provides methods and apparatus for forming an image of a scene comprising a source of emitted or reflected light. The scene is illuminated and a first image corresponding to the illuminated scene is recorded. Illumination is ceased, and a second image of the emitted or reflected light, corresponding to the non-illuminated scene, is recorded. The second image is used to generate a marker in the first image, said marker indicating the position of the emitted or reflected light.

While the present invention has been discussed with particular reference to surgical endoscopy, it will be understood that the present invention finds application in many other fields, such as the internal inspection of machinery, or identification of any objects within scenes where ambient illumination may be controlled.

1.-17. (canceled)

18. A method for forming an image of a scene comprising a source of emitted or reflected light, the method comprising the steps of:
illuminating the scene and recording a first image corresponding to the illuminated scene;
ceasing illumination of the scene, and recording a second image of emitted or reflected light, corresponding to the non-illuminated scene;
generating a marker according to the second image, said marker indicating the position of the emitted or reflected light in the second image; and
adding the marker into the first image.

19. The method according to claim 18, for forming color images, wherein the step of illuminating the scene and recording a first image corresponding to the illuminated scene comprises the sub-steps of:
illuminating the scene with a selected color of light;
recording an image corresponding to the scene illuminated by the selected color of light;
repeating the preceding two sub-steps with at least one further selected color of light; and
assembling the recorded images together to form a color image corresponding to the scene, being the said first image.

20. The method according to claim 18, wherein the step of adding a marker into the first image comprises selecting a representation of the marker which offers high contrast with respect to the surrounding part of the first image.

21. The method according to claim 20, wherein the selection of a representation comprises selection of a color in which the marker is shown in the resulting image.

22. The method according to claim 21, wherein the selection of a representation comprises selection of a texture in which the marker is shown in the resulting image.

23. The method according to claim 21, wherein the selection of a representation comprises generation of a contour ring, which is shown in the resulting image.

24. The method according to claim 18, further comprising the step of subtracting the second image from the first image.

25. The method according to claim 18, comprising the step of inhibiting the source of emitted or reflected light during the step of illuminating the scene and recording a first image corresponding to the illuminated scene.

26. Apparatus for forming an image of a scene comprising a source of emitted or reflected light, comprising:
a source of light for illuminating the scene;
a controller for controlling operation of the source of light;
storage means for recording a first image corresponding to the scene illuminated by the source of light;
further storage means for recording a second image of the emitted or reflected light, corresponding to the non-illuminated scene; and
an image processing device for generating a marker according to the second, said marker indicating the position of the emitted or reflected light in the second image, and adding the marker in the first image.

27. The apparatus according to claim 26 for forming color images, wherein
the controller controls the light source to illuminate the scene sequentially with a plurality of selected colors of light;
the storage means comprises a corresponding plurality of storage means, each for recording a corresponding image for the scene illuminated by a respective one of the plurality of selected colors of light;
the apparatus further comprising:
an image processing device for combining the recorded images together to form a color image corresponding to the scene, being the said first image.

28. The apparatus according to claim 26, wherein the marker added into the first image comprises a representation of the marker, the representation being selected to offer high contrast with respect to the surrounding part of the first image.

29. The apparatus according to claim 28, wherein the representation comprises a color in which the marker is shown in the resulting image.

30. The apparatus according to claim 28, wherein the representation comprises a texture in which the marker is shown in the resulting image.

31. The apparatus according to claim 26, wherein the representation comprises a contour ring, which is shown in the resulting image.

32. The apparatus according to claim 26, wherein the controller controls the source of emitted or reflected light while the scene is illuminated.
